(19) United States
(12) Patent Application Publication
(10) Pub. No.: US 2023/0319063 A1
(43) Pub. Date: Oct. 5, 2023

(54) METHOD AND SYSTEM FOR SECURING NETWORK FUNCTIONS IN DISAGGREGATED NETWORKS

(71) Applicant: INFOSYS LIMITED, Bangalore (IN)

(72) Inventors: Sreekanth SREEDEVI SASIDHARAN, Thiruvananthapuram (IN); Hariharan BALASUBRAMANIAN, Bangalore (IN); Anuj TANEJA, YAMUNANAGAR (IN)

(21) Appl. No.: 17/707,253

(22) Filed: Mar. 29, 2022

(30) Foreign Application Priority Data
Mar. 29, 2022 (IN) 20224101842

(51) Int. Cl. H04L 9/40

(52) U.S. Cl. CPC H04L 63/1416; H04L 63/1425; H04L 63/20; H04L 63/0236

(57) ABSTRACT

Embodiments of the present disclosure discloses a method, an apparatus and a system for securing Network Functions (NFs) in a disaggregated network. The apparatus receives metrics and events related to one or more Network functions from an agent deployed in a host system. The apparatus validates the metrics and events by comparing with reference metrics and events. Further, the apparatus detects a threat in the disaggregated network based on the validation and performs one or more actions. The proposed solution helps in detecting an attack that originates from within a host machine of the disaggregated network, isolate the rogue NF and perform actions to protect the rest of the disaggregated network.

This application claims the benefit of Indian Patent Application No. 202241018242, filed Mar. 29, 2022, which is incorporated by reference in its entirety.

### TECHNICAL FIELD

The present disclosure relates in general to computer network security. Particularly, but not exclusively, the present disclosure relates to method, apparatus and system for securing network functions in disaggregated networks.

### BACKGROUND

Network Function Disaggregation (NFD) defines the evolution of switching and routing appliances from proprietary, closed hardware and software sourced from a single Original Equipment Manufacturer (OEM), towards decoupled, open components which are combined to form a complete switching and routing device. NFD allows employing commercial off-the shelf hardware to be integrated with network software. Thus, the product is tailored for each application. However, the disaggregation brings a new challenge in terms of security. Intrusion detection is the practice of identifying inappropriate, unauthorized, or malicious activity in computer systems. Systems designed for intrusion detection typically monitor for security breaches perpetrated by external attackers as well as by insiders using the computer system or a computer network.

Existing network security solutions makes a fundamental assumption that the attack always happens from an agent external to the network. Data collected to protect the network are provided by the Network Functions (NF) themselves. The data is collected from top layers such as Virtual Machines (VMs), applications, considering that the underlying host machine and network function software from the OEM is secure and can be trusted. However, due to the disaggregation of the network components, the assumption that the underlying host machine and the network functions are secure and trusted cannot be made anymore. Therefore, there is a need to address the security issue that exists in disaggregated networks where the host machine can be compromised.

The information disclosed in this background of the disclosure section is only for enhancement of understanding of the general background of the invention and should not be taken as an acknowledgment or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

In one embodiment, the present disclosure discloses a method for securing Network Functions (NFs) in a disaggregated network. The method comprises receiving, by a computing unit, from an agent deployed in a host machine among a plurality of host machines in the disaggregated network, one or more metrics and one or more events of one or more network functions of the host machine; validating, by the computing unit, the one or more metrics and the one or more events by comparing the one or more metrics and the one or more events with reference metrics and reference events stored in one or more databases; and detecting, by the computing unit, a threat based on the validating when the one or more metrics and the one or more events do not match the reference metrics and the reference events, wherein one or more actions are performed upon detecting the threat.

In one embodiment, the present disclosure discloses a computing unit for securing Network Functions (NFs) in a disaggregated network. The computing unit comprises one or more processors; and a memory communicatively coupled with the one or more processors. The one or more processors are configured to receive from an agent deployed in a host machine among a plurality of host machines in the disaggregated network, one or more metrics and one or more events of one or more network functions of the host machine; validate the one or more metrics and the one or more events by comparing the one or more metrics and the one or more events with reference metrics and reference events stored in one or more databases; and detect a threat based on the validating when the one or more metrics and the one or more events do not match the reference metrics and the reference events, wherein one or more actions are performed upon detecting the threat.

In an embodiment, the present disclosure discloses a system for securing Network Functions (NFs) in a disaggregated network. The system comprises an agent deployed in a host machine among a plurality of host machines in the disaggregated network; and a computing unit. The agent is configured to receive policies from the computing unit; monitor one or more metrics and one or more events of one or more network functions of the host machine; and transmit the one or more metrics and the one or more events to the computing unit. The computing unit is configured to receive from an agent deployed in a host machine among a plurality of host machines in the disaggregated network, one or more metrics and one or more events of one or more network functions of the host machine; validate the one or more metrics and the one or more events by comparing the one or more metrics and the one or more events with reference metrics and reference events stored in one or more databases; and detect a threat based on the validating when the one or more metrics and the one or more events do not match the reference metrics and the reference events, wherein one or more actions are performed upon detecting the threat.

In an embodiment, the present disclosure discloses a non-transitory computer readable medium for securing network functions in a disaggregated network (102), having stored thereon one or more instructions that when processed by at least one processor cause a device to perform operations comprising receiving from an agent deployed in a host machine among a plurality of host machines in the disaggregated network, one or more metrics and one or more events of one or more network functions of the host machine; validating the one or more metrics and the one or more events by comparing the one or more metrics and the one or more events with reference metrics and reference events stored in one or more databases; and detecting a threat based on the validating when the one or more metrics and the one or more events do not match the reference metrics and the reference events, wherein one or more actions are performed upon detecting the threat

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 illustrates a disaggregated network and a computing unit for securing Network Functions (NFs) in the disaggregated network, in accordance with some embodiments of the present disclosure;

FIG. 2 shows a system for securing a Network Function (NF) of a host machine, in accordance with some embodiments of the present disclosure;

FIG. 3 shows a block diagram of a computing unit—for securing Network Functions (NFs) in a disaggregated network, in accordance with some embodiments of the present disclosure;

FIG. 4 shows a flowchart illustrating method steps for securing Network Functions (NFs) in the disaggregated network, in accordance with some embodiments of the present disclosure;

FIG. 5a-5j illustrates user interface of computing unit, in accordance with some embodiments of the present disclosure; and

FIG. 6 shows a block diagram of a general-purpose computer for securing Network Functions (NFs) in the disaggregated network, in accordance with an embodiment of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes, which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure discloses a method, an apparatus (computing unit) and a system for securing Network Functions (NFs) in a disaggregated network. The proposed solution helps in detecting an attack that originates from within a host machine of the disaggregated network, isolate the rogue NF and perform actions to protect the rest of the disaggregated network.

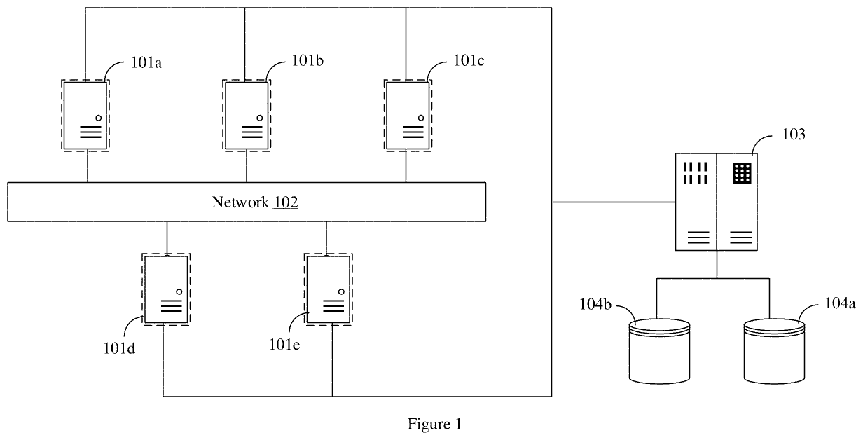

FIG. 1 shows a network architecture. In an embodiment, the network may be a disaggregated network (102). The disaggregated network (102) allows integration of off-the shelf hardware with network software from different Original Equipment Manufacturers (OEMs). The combination of hardware and software allows the product to be tailored for each application. For example, a network switch from vendor 1 and software for the network switch from vendor 2 can be combined. The disaggregated network (102) is formed by a plurality of host machines (101a, 101b, 10c, 101d, 101e). The plurality of host machines (101a, 101b, 10c, 101d, 101e) may include network components such as a routes, a switch, a hub, a modem, a Network Interface Card (NIC), a network server, an Internet Service Provider (ISP). The disaggregated network (102) may also include end devices such as printers, laptops, mobile, etc., (not shown in FIG. 1). In an exemplary embodiment, the disaggregated network (102) may be a 5G communication network. As known in the art, the 5gG communication network may include network components such as gNode-b (gNb), Access and Mobility network Function (AMF), Session Management network Function (SMF), Policy Control Function (PCF), Unified Data Management (UDM) and a Data Network (DN). The present disclosure is not limited only to 5G network and is applicable to any network where disaggregated network components are used, such as wireline networks, Wireless Fidelity (Wi-Fi) networks, enterprise networks.

In an embodiment, the plurality of host machines (101a, 101b, 10c, 101d, 101e) may implement Network Functions (NFs) that may or may not be virtualized. If the NFs are virtualized, then the NFs may be implemented in private or public cloud servers. Examples of the NFs may include, but not limited to, network routing such as Domain Name Service (DNS), Natural Address Translation (NAT) and Broadband Network Gateway (BNG) services, security such as malware detection, intrusion detection and Virtual Private Network (VPN) services, traffic analysis, prediction and Quality of Service (QoS) measurement, network and resource load balancing.

FIG. 1 also shows a computing unit (103) (also referred as apparatus). In one embodiment, the computing unit (103) may not be part of the disaggregated network (102). As the proposed solution considers a possibility of a potential threat that may lie within the disaggregated network (102), for example at a kernel level of a host machine (e.g., 101a), the computing unit (103) may lie outside the disaggregated network (102) and determine, analyze and perform one or more actions when a threat is detected. The computing unit (103) is further connected to one or more databases (104a, 104b). The one or more databases (104a, 104b) may store one or more metrics and one or more events of the NFs of the plurality of host machines (101a, 101b, 10c, 101d, 101e). In an exemplary embodiment, the database (104a) may store the one or more metrics and the database (104b) may store the one or more events. The one or more metrics may include but not limited to, memory usage, accessibility of hardware, processing cycles, protection rings and the like. The one or more events may include, but not limited to, unauthorized port usage, memory overflow, unauthorized system calls and the like. The computing unit (103) receives the one or more events and the one or more metrics from an agent installed in each of the plurality of the host machines (101a, 101b, 10c, 101d, 101e). In one embodiment, more than one agent may be installed in each host machine. In an embodiment, the computing unit (103) may communicate with the agent of host machines (101a, 101b, 10c, 101d, 101e) via a dedicated network. The computing unit (103) validates the one or more metrics and the one or more events and detects a threat in the NFs. When the threat is detected, one or more actions are performed to mitigate the threat.

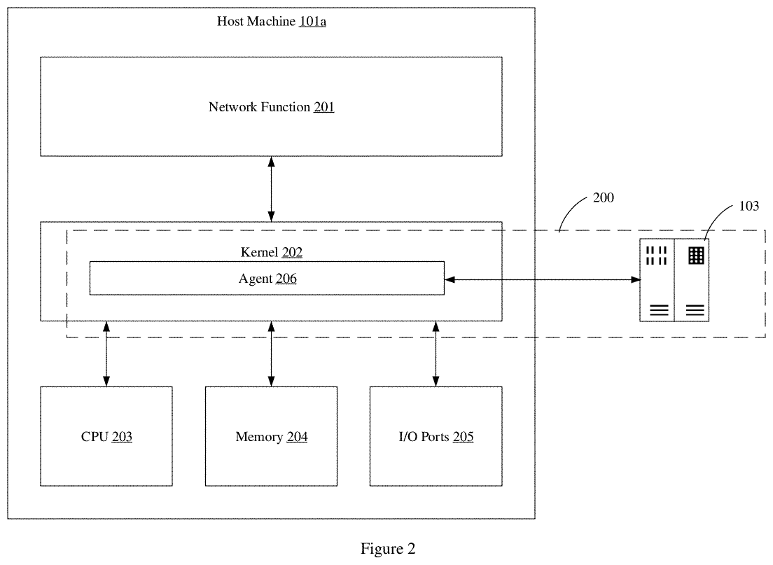

Referring now to FIG. 2, a system (200) is disclosed. The system (200) comprises the computing unit (103) and at least one agent (206) of a host machine (e.g., 101a). As shown in the FIG. 2, the host machine (101a) comprises one or more NFs (201), a kernel (202), one or more CPUs (203), a memory (204), and I/O ports (205). The one or more NFs (201) may be deployed as one of, an operating system, a bootloader, a Containerized Network Function (CNF), a Virtualized Network Function (VNF), a combination of VNF and CNF, a network application, a virtual machine, and a physical or virtual network port. In an embodiment, the agent (206) is deployed in lowest software layer such as the kernel (202). The agent (206) is configured to monitor the one or more metrics and the one or more events caused in the host machine (101a). In an embodiment, the agent (206) is hooked to the kernel (202) using a hooking mechanism. The agent may be a function that can intercept function calls, events and messages in the kernel (202). The hooking mechanism may include physical modification or software modification in the kernel (202) or runtime modification. In one embodiment, the agent (206) may be developed using Java, C, C++, BASIC, and the like. The agent (206) may communicate with the computing unit (103) over a de dedicated network. The computing unit (103) and the agent (206) may communicate using server/client communication techniques. For example, the dedicated network may use sockets, Remote Procedure Calls (RPC) or pipes for communication.

In an embodiment, the computing unit (103) may be deployed on a cloud server. For example, the computing unit (103) may be hosted on a hypervisor, a Virtual Machine (VM) or in a docker container.

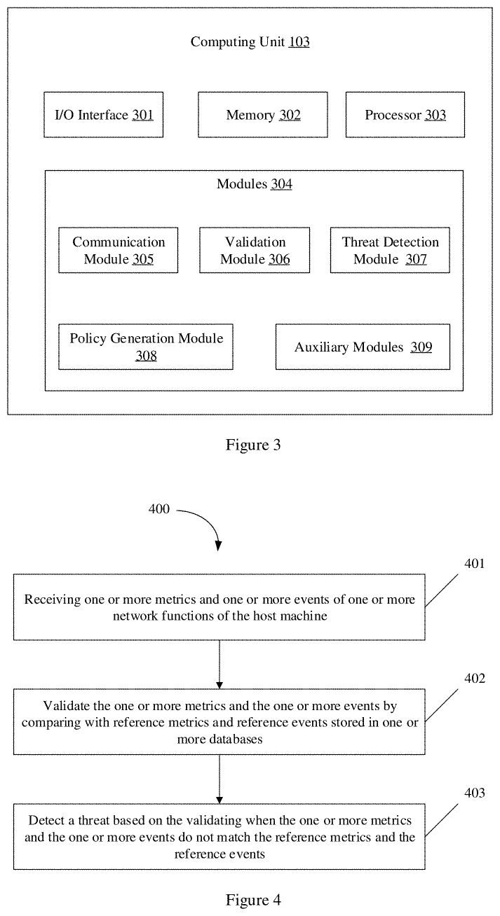

Reference is now made to FIG. 3 which shows a block diagram of the computing unit (103). The computing unit (103) may include Central Processing Unit (“CPU” or “processor”) (303), a memory (302) storing instructions executable by the processor (303). The processor (303) may include at least one data processor for executing program components for executing user or system-generated requests. The memory (302) may be communicatively coupled to the processor (303). The computing unit (103) further includes an Input/Output (I/O) interface (301). The I/O interface (301) may be coupled with the processor (203) through which an input signal or/and an output signal may be communicated.

In some embodiments, the computing unit (103) comprises modules (304). The modules (304) may be stored within the memory (302). In an example, the modules (204) are communicatively coupled to the processor (303) and may also be present outside the memory (302) as shown in FIG. 3 and implemented as hardware. As used herein, the term modules (304) may refer to an application specific integrated circuit (ASIC), a Field Programmable Gate Array (FPGA), an electronic circuit, a processor (303) (shared, dedicated, or group), and memory (302) that execute one or more software or firmware programs, a combinational logic circuit, and/or other suitable components that provide the described functionality. In some other embodiments, the modules (304) may be implemented using at least one of ASICs and FPGAs. In an embodiment, an Input/Output (I/O) interface (301) may enable communication between the computing system (103) and the agent (206).

In one implementation, the modules (304) may include, for example, a communication module (305), a validation module (306), a threat detection module (307), a policy generation module (308) and auxiliary modules (309). It may be appreciated that such aforementioned modules (304) may be represented as a single module or a combination of different modules (304).

In an embodiment the communication module (305) is configured to facilitate communication between the computing unit (103) and the one or more databases (104a, 104b). The communication module (305) facilitates in receiving the one or more reference metrics and one or more reference events from the one or more databases (104a, 104b). Further, the communication module also facilitates communication with the agent (206). The communication module (305) may use server/client communication protocol to communicate with the agent (206). In one embodiment, the communication module (305) can communicate with the agent (206) of the plurality of host machines (101a, 101b, 101c, 101d, 101e) to receive the one or more metrics and the one or more events monitored by the agent (206) of respective host machine from the plurality of host machines (101a, 101b, 101c, 101d, 101e). The communication module (305) receives the one or more metrics and the one or more events periodically from the agent (206), and transmits the policies periodically to the agent (206).

In an embodiment, the validation module (306) is configured to validate the one or more metrics and the one or more events. The validation module (306) compares the one or more metrics and the one or more events received from the agent (206) with the one or more reference metrics and the one or more reference events received from the one or more databases (104a, 104b). In an embodiment, the validation module (306) may correlate the received one or more metrics and the one or more events with known patterns of the one or more metrics and the one or more events. For example, the validation module (306) may compare the one or more metrics and the one or more events received from the agent (206) with known patterns of metrics and events that has caused a threat in the disaggregated network (102). In another embodiment, the one or more reference metrics and the one or more reference events may be expected or normal metrics and events. The unexpected/expected patterns may be generated using one or more AI techniques. For example, Deep Neural Networks (DNN) may be used to analyze historical metrics data and events data received from the agent (206) to find a pattern of abnormal/normal metrics and/or events. In an embodiment, the validation may be performed for a single host machine (e.g., 101a) or for a cluster of host machines from the plurality of host machines (101a, 101b, 101c, 101d, 101e).

In an embodiment, the threat detection module (307) is configured to detect a threat in the disaggregated network (102) based on the validation. In one embodiment, the threat detection module (307) detects a threat in the disaggregated network (102) when the comparison returns a match between the one or more metrics, the one or more events with abnormal patterns or metrics and events. In another embodiment, the threat detection module (307) detects a threat in the disaggregated network (102) when the comparison returns a mis-match between the one or more metrics, the one or more events with normal patterns or metrics and events. In an embodiment, the threat detection module (307) may further determine the type of threat and classify the threat. For example, the threat detection module (309) may classify the threat as a system call. Furthermore, the threat detection module (307) may prioritize the threats when more than one threats are detected. Also, when the threat is detected in more than one host machine, the threat may be prioritized based on which hist machine the threat is determined. For example, a threat detected in an ISP may be more severe than a threat detected in a local router. In an embodiment, the threat detection module (307) may predict the threat based on a pattern of the one or more metrics.

In an embodiment, the policy generation module (308) is configured to generate policies. The one or more metrics and the one or more events are determined based on the policies. The one or more NFs are identified in the host device (e.g., 101a) and operating limits and access limits are set to each of the one or more NFs based on at least a type of the one or more NF, location of the host device hosting the one or more NF, and operations associated with the one or more NFs. Setting operating limits and access limits comprises setting thresholds for operations performed by the one or more network functions and restrictions to access data and/or other host devices among the plurality of host devices. Further, the policies are defined for each NF. The policies are defined based on one of, rules or historical analysis. The policies may be defined using the one or more AI techniques—(supervised or unsupervised techniques can be used to generate the policies). For example, a policy may be defined to protect memory of a network server. The metrics related to the memory may include memory overflow. The policies may be stored in a dedicated database such as a PCF in the 5G network. The policies are used to create filters at the kernel level and to create boundary conditions for the one or more metrics. The policies may be generated custom for a type of work loads or environments and other network header parameters.

In an embodiment, the auxiliary modules (309) may include, but not limited to a user interface, an agent management module, a threat mitigation module.

The user interface may provide a dashboard. The dashboard provides a dynamic view or an operator view of the disaggregated network (102). An operator can view the alerts/NF count and how the alerts vary. The dashboard may also provide a historic view of the policies and which policies are best utilized. The user interface may further display clusters. Visualization of the clusters (Open stack/Kubernetes) and the nodes in each cluster with the security framework may be displayed. The user interface may also display the NFs. A view of the policies linked to each NF and the option to link or unlink policies from the NFs. The user interface further enables the operator to create different types of policies and hierarchically link such that base policies can be inherited across different networks. The user interface provides a view of the alerts/notifications for enabling security maintenance activity. The alerts may be provided on emails, messenger, communicator platforms, etc.

The agent commissioning module may commission or decommission the agent (206) in the host machine (e.g., 101a). Commissioning includes activating the agent (206), configuring roles to the agent (206), receiving real-time metrics and events from the agent (206), uploading policies to the agent (206), providing actions/recommendations upon detecting alert to the agent (206).

The threat mitigation module may be configured to perform the one or more actions upon a threat is detected. The one or more actions includes, at least one of, generating an alert, restarting the one or more NFs, shutting down the one or more NFs, and isolating the one or more NFs from the disaggregated network (102), alerting other NFs among the cluster.

FIG. 4 shows a flowchart illustrating a method for securing the one or more NFs, in accordance with some embodiment of the present disclosure. The order in which the method (400) may be described is not intended to be construed as a limitation, and any number of the described method blocks may be combined in any order to implement the method. Additionally, individual blocks may be deleted from the methods without departing from the spirit and scope of the subject matter described herein. Furthermore, the method may be implemented in any suitable hardware, software, firmware, or combination thereof.

At step (401) receiving, by the computing unit (103) from the agent (206) deployed in the host machine (101a) among the plurality of host machines (101a, 101b, 101c, 101d, 101e) in the disaggregated network (102), the one or more metrics and the one or more events of one or more NFs of the host machine (101a).

At step (402), validating, by the computing unit (103), the one or more metrics and the one or more events by comparing the one or more metrics and the one or more events with reference metrics and reference events stored in one or more databases (104a, 104b).

At step (403), detecting, by the computing unit (103), a threat based on the validating the one or more metrics and the one or more, wherein one or more actions are performed upon detecting the threat.

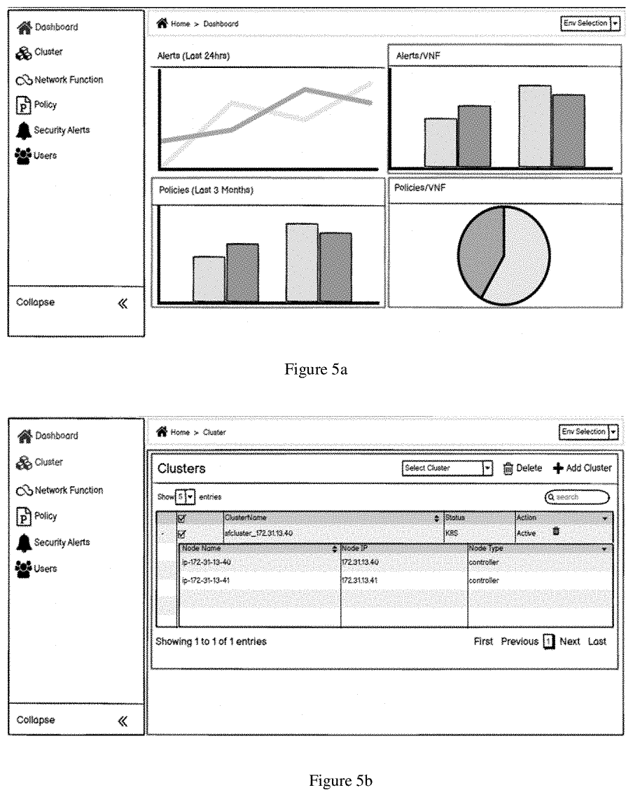

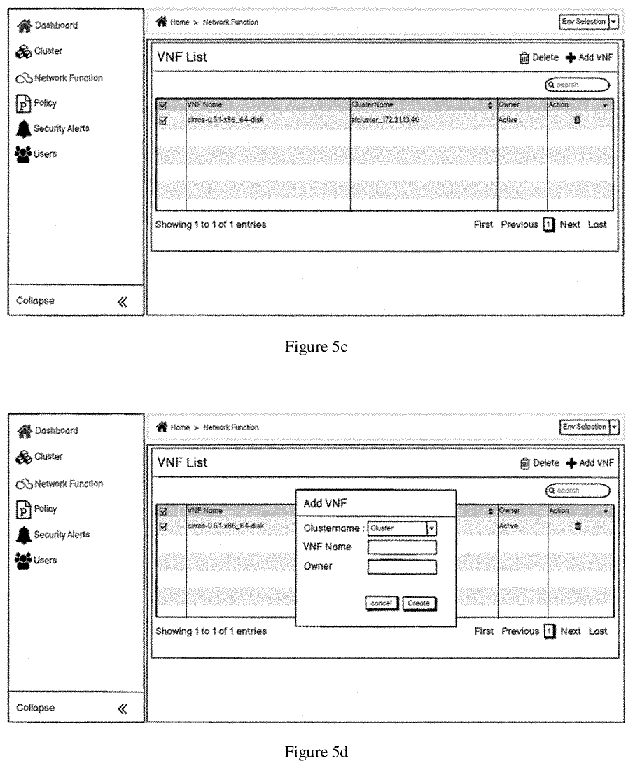

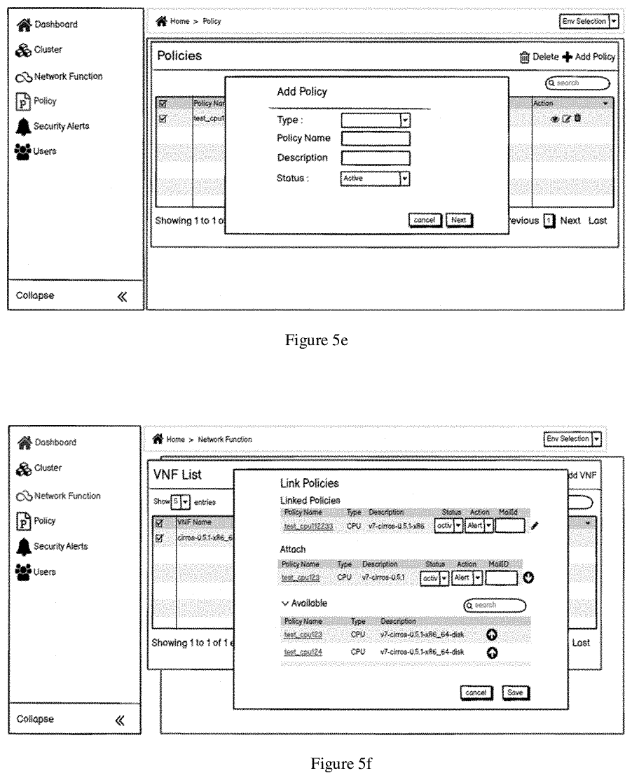

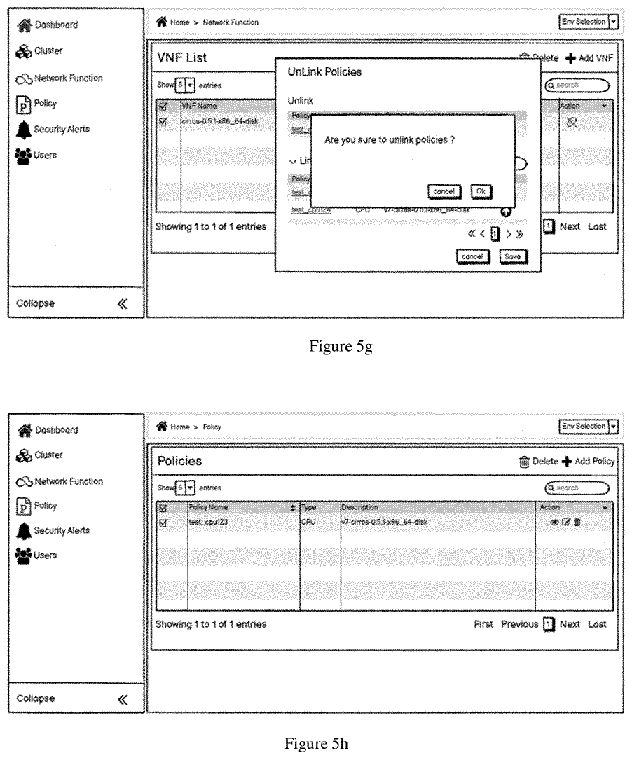

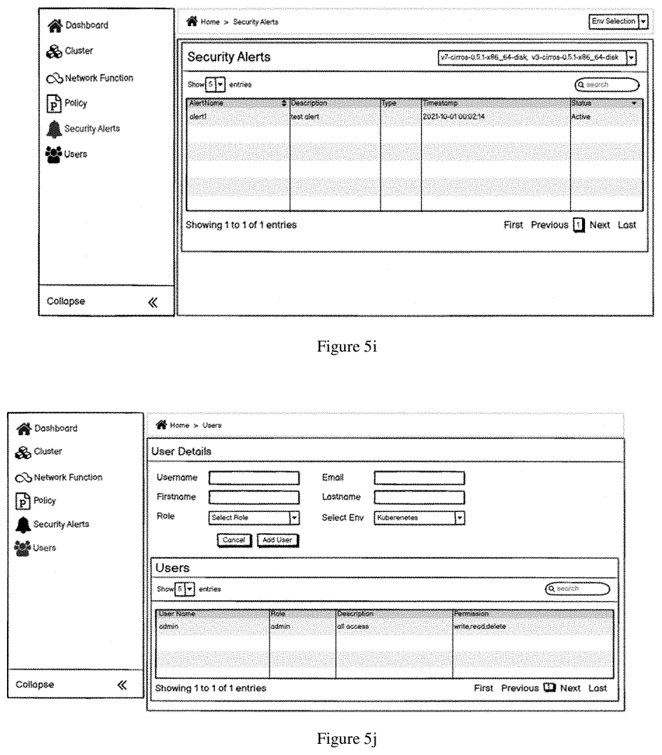

FIG. 5a shows the exemplary dashboard view of the user interface illustrating the one or more events with real time data visuals. The dashboard provides detailed information on the number of alerts per NF, the alerts in past 24 hours, policies for the last 3 months and the number of policies per NF. FIG. 5b shows the dashboard view where the operator can visualize the clusters (Open stack/Kubernetes) and the nodes in each cluster. FIG. 5c and FIG. 5d show an exemplary dashboard view where the operator views the NFs available on the cluster in the user interface. FIG. 5e, FIG. 5f, FIG. 5g, FIG. 5h show an exemplary dashboard view for managing policies for the NFs. FIG. 5i and FIG. 5j show exemplary dashboard view of viewing alerts and performing the one or more action in response to detecting a threat.

The proposed solution adds less load on the disaggregated network (102) as the agent (206) is light weight and is executed on the kernel (202). The agent (206) consumes less CPU cycles and leaves negligible memory footprint. The policies created using the proposed solution reduces the load of monitoring data transmitted to the computing unit (103). The proposed solution mitigates the risk that appears at the kernel level. The proposed solution can achieve high scalability and reliability by using decoupled components and modules and hence able to analyze high volumes of events in real-time.

### Computer System

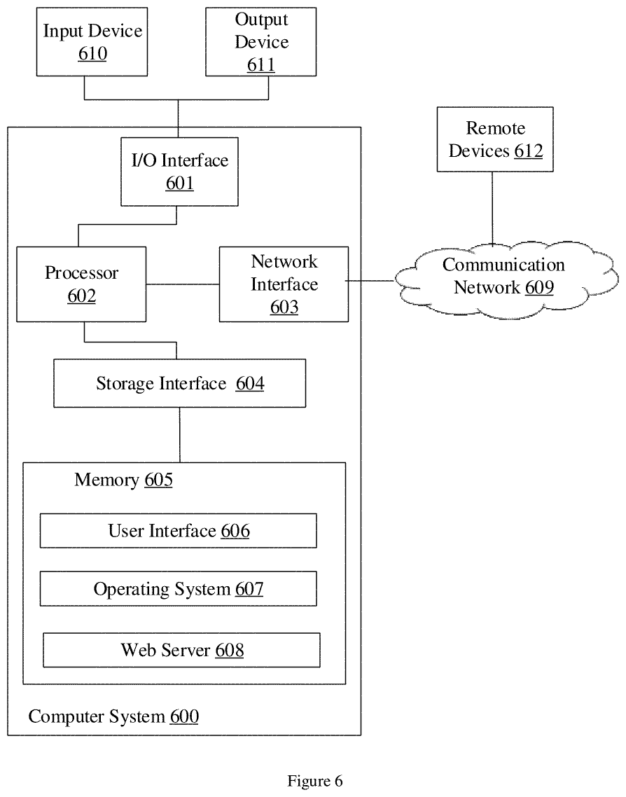

FIG. 6 depicts a block diagram of a general-purpose computer for securing network functions in the disaggregated network (102), in accordance with an embodiment of the present disclosure. The computer system (600) may comprise a central processing unit (“CPU” or “processor”) (602). The processor (602) may comprise at least one data processor. The processor (602) may include specialized processing units such as integrated system (bus) controllers, memory management control units, floating point units, graphics processing units, digital signal processing units, etc. The computer system (600) may be analogous to the computing unit (103).

The processor (602) may be disposed in communication with one or more input/output (I/O) devices (not shown) via I/O interface (601). The I/O interface (601) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (601), the computer system (600) may communicate with one or more I/O devices. For example, the input device (610) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (611) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (600) is connected to the remote devices (612) through a communication network (609). The remote devices (612) may be the agent (206). The processor (602) may be disposed in communication with the communication network (609) via a network interface (603). The network interface (603) may communicate with the communication network (609). The network interface (603) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (609) may include, without limitation, a direct interconnection, local area network (LAN), wide area network (WAN), wireless network (e.g., using Wireless Application Protocol), the Internet, etc. Using the network interface (603) and the communication network (609), the computer system (600) may communicate with the remote devices (612). The network interface (603) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network (609) includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, 3GPP and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor (602) may be disposed in communication with a memory (607) (e.g., RAM, ROM, etc. not shown in FIG. 6) via a storage interface (604). The storage interface (604) may connect to memory (607) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (607) may store a collection of program or database components, including, without limitation, user interface (606), an operating system (607), web server (608) etc. In some embodiments, computer system (600) may store user/application data, such as, the data, variables, records, etc., as described in this disclosure. Such databases may be implemented as fault-tolerant, relational, scalable, secure databases such as Oracle® or Sybase®.

The operating system (607) may facilitate resource management and operation of the computer system (600). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system (600) may implement a web browser (608) stored program component. The web browser (608) may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (608) may utilize facilities such as AJAX™, DHTML™, ADOBE® FLASH™, JAVASCRIPT™, JAVA™, Application Programming Interfaces (APIs), etc. In some embodiments, the computer system (600) may implement a mail server stored program component. The mail server may be an Internet mail server such as Microsoft Exchange, or the like. The mail server may utilize facilities such as ASP™, ACTIVEX™, ANSI™ C++/C #, MICROSOFT®, .NET™, CGI SCRIPTS™, JAVA™, JAVASCRIPT™, PERL™ PHP™ PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system (600) may implement a mail client stored program component. The mail client may be a mail viewing application, such as APPLE® MAIL™ MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices, which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is, therefore, intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

We claim:

1. A method for securing network functions in a disaggregated network, the method comprising:
receiving, by a computing unit, from an agent deployed in a host machine among a plurality of host machines in the disaggregated network, one or more metrics and one or more events of one or more network functions of the host machine;
validating, by the computing unit, the one or more metrics and the one or more events by comparing the one or more metrics and the one or more events with reference metrics and reference events stored in one or more databases; and
detecting, by the computing unit, a threat based on the validating the one or more metrics and the one or more, wherein one or more actions are performed upon detecting the threat.

2. The method of claim 1, wherein the one or more metrics and the one or more events are determined based on policies defined for each of the one or more network functions.

3. The method of claim 2, wherein the policies are defined based on one or more of: rules or historical analysis.

4. The method of claim 2, wherein the policies are defined by performing:
identifying the one or more network functions of the host machine; and
setting operating limits and access limits to each of the one or more network functions based on at least a type of the one or more network function, location of the host machine hosting the one or more network functions, and operations associated with the one or more network functions.

5. The method of claim 4 wherein, setting operating limits and access limits comprises setting thresholds for operations performed by the one or more network functions and restrictions to access data and/or other host machines among the plurality of host machines.

6. The method of claim 1, wherein the one or more network functions are deployed as one of an operating system, a bootloader, a Containerized Network Function (CNF), a Virtualized Network Function (VNF), a combination of VNF and CNF, a network application, a virtual machine, and a physical or virtual network port.

7. The method of claim 1, wherein the one or more metrics and the one or more events are received periodically from the agent, and the policies are periodically transmitted to the agent 206.

8. The method of claim 1, wherein the agent is hooked to a kernel of the host machine using a hooking mechanism.

9. The method of claim 1, wherein the one or more actions comprise at least, generating an alert, restarting the one or more network functions, shutting down the one or more network functions, and isolating the one or more network functions from the disaggregated network.

10. The method of claim 9, wherein the alert is provided on a user interface for enabling security maintenance activity.

11. A computing unit for securing network functions in a disaggregated network, comprising:
one or more processors; and
a memory communicatively coupled with the one or more processors, which causes the one or more processors to:
receive from an agent deployed in a host machine among a plurality of host machines in the disaggregated network, one or more metrics and one or more events of one or more network functions of the host machine;
validate the one or more metrics and the one or more events by comparing the one or more metrics and the one or more events with reference metrics and reference events stored in one or more databases; and
detect a threat based on the validating of the one or more metrics and the one or more events, wherein one or more actions are performed upon detecting the threat.

12. The computing unit of claim 11, wherein the one or more processors (303) are configured to determine the one or more metrics and the one or more events based on policies defined for each of the one or more network functions.

13. The computing unit of claim 12, wherein the one or more processors define the policies based on one or more of: rules or historical analysis.

14. The computing unit of claim 12, wherein the one or more processors are configured to define the policies, wherein the one or more processors are configured to:
identify the one or more network functions of the host machine; and
set operating limits and access limits to each of the one or more network functions based on at least a type of the one or more network function, location of the host machine hosting the one or more network functions, and operations associated with the one or more network functions.

15. The computing unit of claim 14, wherein the one or more processors are configured to set operating limits and access limits, wherein the one or more processors are configured to set thresholds for operations performed by the one or more network functions and restrictions to access data and/or other host machine among the plurality of host machines.

16. The computing unit of claim 11, wherein the one or more processors are configured to:
periodically receive the one or more metrics and the one or more events from the agent, and
periodically transmit the policies to the agent.

17. The computing unit of claim 14, wherein the one or more processors are further configured to:
perform the one or more actions comprising at least, generating an alert, restarting network function, shutting down the network function, and isolating the network function from the disaggregated network.

18. The computing unit of claim 17, wherein one or more processors are configured to provide the alert on a user interface for enabling security maintenance activity.

19. A system for securing network functions in a disaggregated network, comprising:
an agent deployed in a host machine among a plurality of host machines in the disaggregated network; and
a computing unit according to one or more of claims 10-17;
wherein the agent is configured to:
receive policies from the computing unit;
monitor one or more metrics and one or more events of one or more network functions of the host machine; and
transmit the one or more metrics and the one or more events to the computing unit, wherein the agent is hooked to a kernel of the host machine using a hooking mechanism.

20. A non-transitory computer readable medium for securing network functions in a disaggregated network, having stored thereon one or more instructions that when processed by at least one processor cause a device to perform operations comprising:
receiving from an agent deployed in a host machine among a plurality of host machines in the disaggregated network, one or more metrics and one or more events of one or more network functions of the host machine;
validating the one or more metrics and the one or more events by comparing the one or more metrics and the one or more events with reference metrics and reference events stored in one or more databases; and
detecting a threat based on the validating of the one or more metrics and the one or more events, wherein one or more actions are performed upon detecting the threat.
